(19) United States
(12) Patent Application Publication
(10) Pub. No.: US 2015/0381597 A1
(43) Pub. Date: Dec. 31, 2015

(54) ENTERPRISE MANAGEMENT FOR SECURE NETWORK COMMUNICATIONS OVER IPSEC

(71) Applicants: Robert A Johnson, Pottstown, PA (US); David S Dodgson, Lansdale, PA (US); Daniel Keiser, Malvern, PA (US); Jawahar Bharatia, Malvern, PA (US)

(72) Inventors: Robert A Johnson, Pottstown, PA (US); David S Dodgson, Lansdale, PA (US); Daniel Keiser, Malvern, PA (US); Jawahar Bharatia, Malvern, PA (US)

(73) Assignee: Unisys Corporation, Blue Bell, PA (US)

(21) Appl. No.: 14/688,348

(22) Filed: Apr. 16, 2015

Related U.S. Application Data
(60) Provisional application No. 62/018,967, filed on Jun. 30, 2014.

(51) Int. Cl. H04L 29/06; H04L 12/24; G06F 21/10; H04L 29/08

(52) U.S. Cl. CPC H04L 63/08; H04L 67/30; H04L 41/08; H04L 67/02; G06F 21/105

(57) ABSTRACT

Methods and systems for managing a secure enterprise are disclosed. One method includes initiating a management service at a server within the secure enterprise, the management service including a web interface providing administrative access to configuration settings associated with the secure enterprise, the management service initializing a secure communications protocol and managing access to a credential store, the credential store including a plurality of credentials defining communities of interest within the secure enterprise, each of the communities of interest defining a collection of authenticated endpoints having common access and usage rights. The method includes initiating an object management service at the server defining an interface to a configuration database, and accessing the configuration database to obtain data defining a configuration of the enterprise according to a configuration profile. The method includes applying configuration settings to the secure enterprise based on the data defining the configuration of the secure enterprise.

### CROSS-REFERENCE TO RELATED APPLICATIONS

The present application claims priority from U.S. Provisional Patent Application No. 62/018,967 (Docket Ref No. TN625P), the disclosure of which is hereby incorporated by reference in its entirety.

The present application is also related to, and claims priority from the following related and commonly assigned U.S. Patent Applications:

U.S. Provisional Patent Application entitled: Distributed Security on Multiple Independent Networks using Secure “Parsing” Technology, by Robert Johnson, Attorney Docket No. TN400.P, Ser. No. 60/648,531, filed Jan. 31, 2005.

U.S. Patent Application entitled: Integrated Multi-Level Security System, by Robert Johnson, Attorney Docket No. TN400.US, Ser. No. 11/339,974 filed Jan. 31, 2006, claiming the benefit of the previous provisional application.

U.S. Patent Application entitled: Integrated Multi-Level Security System, by Robert Johnson et al., Attorney Docket No. TN400.USCIP1, Ser. No. 11/714,590 filed Mar. 6, 2007 which is a continuation-in-part of U.S. application Ser. No. 11/339,974.

U.S. Patent Application entitled: Integrated Multi-Level Security System, by Robert Johnson et al., Attorney Docket No. TN400.USCIP2, Ser. No. 11/714,666 filed Mar. 6, 2007 which is a continuation-in-part of U.S. application Ser. No. 11/339,974.

U.S. Patent Application entitled: Integrated Multi-Level Security System, by Robert Johnson et al., Attorney Docket No. TN400.USCIP3, Ser. No. 11/714,598 filed Mar. 6, 2007 which is a continuation-in-part of U.S. application Ser. No. 11/339,974.

U.S. patent application Ser. No. 12/272,012, entitled “Block Level Data Storage Security System”, filed Nov. 17, 2008, Attorney Docket No. TN497.

The present disclosure also incorporates by reference the disclosures of commonly assigned applications including:

U.S. patent application Ser. No. 12/336,558, entitled “Data Recovery Using Error Strip Identifiers”, filed Dec. 17, 2008, Attorney Docket No. TN494.

U.S. patent application Ser. No. 12/336,559 entitled “Storage Security Using Cryptographic Splitting”, filed Dec. 17, 2008, Attorney Docket No. TN496; U.S. patent application Ser. No. 12/336,562, entitled “Storage Security Using Cryptographic Splitting”, filed Dec. 17, 2008, Attorney Docket No. TN496A.

U.S. patent application Ser. No. 12/336,564, entitled “Storage Security Using Cryptographic Splitting”, filed Dec. 17, 2008, Attorney Docket No. TN496B,

U.S. patent application Ser. No. 12/336,568, entitled “Storage Security Using Cryptographic Splitting”, filed Dec. 17, 2008, Attorney Docket No. TN504A.

U.S. patent application. Ser. No. 12/342,636 entitled “Storage Communities Of Interest Using Cryptographic Splitting”, filed Dec. 23, 2008, Attorney Docket No TN498.

U.S. patent application Ser. No. 12/342,575, entitled “Storage Communities Of Interest Using Cryptographic Splitting”, filed Dec. 23, 2008, Attorney Docket No. TN498A, U.S. patent application Ser. No. 12/342,610, entitled “Storage Communities Of Interest Using Cryptographic Splitting”, filed Dec. 23, 2008, Attorney Docket No. TN498B.

U.S. patent application Ser. No. 12/342,379, entitled “Secure Network Attached Storage Device Using Cryptographic Splitting”, filed Dec. 23, 2008, Attorney Docket No. TN499.

U.S. patent application Ser. No. 13/493,023, entitled “Software Handling Of Hardware Error Handling In Hypervisor-Based Systems”, filed Sep. 5, 2012, Attorney Docket No. TN550.

U.S. patent application Ser. No. 13/547,148, entitled “Automated Provisioning of Virtual Machines”, filed Jul. 12, 2012, Attorney Docket No. TN565.

### TECHNICAL FIELD

The present disclosure relates generally to a secure communications system; in particular, the present application relates to an enterprise management system for secure network communications, such as over IPsec.

### BACKGROUND

Enterprise computing networks are often distributed across a large number of locations and interconnected over various private and public communication networks, such as LAN systems at a particular location, and via public communications networks between enterprise locations. Such enterprise computing networks, due to the business needs of the enterprise, often require secure communication among those disparate locations.

Existing computing networks typically utilize an arrangement in which communications within a network are transmitted using cleartext, and use network appliances which manage encryption and communication between enterprise locations to allow for secure communications over public networks. In some cases, encryption or security can be applied within the enterprise as well, for secure data.

However, in environments where data security is particularly sensitive, additional levels of security may be applied. For example, in sonic cases different groups of individuals within an enterprise may require their data to be secured or obscured from other individuals within the same enterprise. In some instances, such entities may utilize localized security appliances, such as those implementing Stealth secured data and communications technology provided by Unisys Corporation of Blue Bell, Pa. Such systems provide additional security benefits by providing a security layer with which users are assigned to “communities of interest”, or COIs, which represent groups of users having common usage, data access, and endpoint access rights. Users outside of an assigned community of interest may lack access to data (as in typical network security or secured folder arrangements), and may also lack any accessibility or visibility into the existence of particular endpoints within a network. In some implementations of the Stealth secured data and communications technology, appliances installed within a network control communications and memberships among communities of interest, and manage authentication issues for endpoints that are access by various users.

Use of such security technologies, and in particular those which utilize on-location secure appliances, result in technical challenges for an enterprise. For example, because of the need for local and public network security, Stealth-based appliances are typically located at each of the premises associated with an enterprise, to efficiently manage intra-premise and inter-premise communications. Because this results in distribution of such appliances at different locations, management of user profiles and memberships in communities of interest can be difficult. Furthermore management of current keys, certificates, and licenses can be both difficult to track in realtime across appliances and among premises. This leads to difficulties in sharing licenses across premises, or use of a particular user's profile at different premises all within the enterprise,

In some versions of the Stealth secured data and communications technology, common security technologies and protocols are used to provide the encryption features required for implementing the various communities of interest. For example, in some cases IPsec-based security protocols and encryption techniques can be used as underlying the Stealth secured data and communications technology architecture. Additionally, in some cases, because such common security technologies and protocols are used, appliances are not required for managing inter-premises communication, since, at least in the case of IPsec, such security technology can be used over public networks. Still, irrespective of whether appliances are required for use, there remains no convenient way to manage COI memberships, memberships of endpoints within an enterprise, and licenses across an enterprise having a plurality of different premises interconnected via both public and private networks

Accordingly, improvements in enterprise management for such a secured enterprise network are desirable.

### SUMMARY

In a first aspect, a method of managing a secure enterprise comprising a plurality of communicatively interconnected endpoints is disclosed. The method includes initiating a management service at a server within the secure enterprise. The management service includes a web interface providing administrative access to configuration settings associated with the secure enterprise. The management service initializes a secure communications protocol and managing access to a credential store. The credential store includes a plurality of credentials defining communities of interest within the secure enterprise, each of the communities of interest defining a collection of authenticated endpoints having common access and usage rights. The method also includes initiating an object management service at the server, the object management service defining an interface to a configuration database. The configuration database stores configuration settings included, in one or more configuration profiles for the enterprise network, and one or more interface definitions useable by the web interface to provide administrative access to the configuration settings. The method includes accessing, via the object management service, the configuration database to obtain data defining a configuration of the enterprise according to a configuration profile. The method further includes applying one or more configuration settings to the secure enterprise based on the data defining the configuration of the secure enterprise.

In a second aspect, an enterprise management system executable on a computing system included within a secure enterprise including a network comprising a plurality of communicatively interconnected secured endpoints is disclosed. The enterprise management system includes a configuration database storing configuration settings included in one or more configuration profiles of an enterprise network and one or more interface definitions. The enterprise management system includes a management service executable by the computing system to provide access to a web interface, the web interface providing administrative access to configuration settings associated with the secure enterprise according to the one or more configuration profiles. The enterprise management system also includes an object management service communicatively connected to the management service and executable by the computing system, the object management service defining an interface to the configuration database. The enterprise management system further includes a credential store managed by the management service and including a plurality of credentials defining communities of interest within the secure enterprise, each of the communities of interest defining a collection of authenticated endpoints having common access and usage rights.

In a third aspect, a secured enterprise comprising a network including a plurality of servers and a plurality of secured endpoints is disclosed. The secured enterprise includes an enterprise management server hosting a management service providing access to a web interface to administrative users and managing access to a credential store, the credential store including a plurality of credentials defining communities of interest within the secure enterprise, each of the communities of interest defining a collection of authenticated endpoints having common access and usage rights, and an object management service defining an interface to a configuration database hosted on the enterprise management server. The secured enterprise farther includes a user interface server communicatively connected to the enterprise management server, the user interface server providing the web interface hosting a plurality of portlets, and an authorization server accessible to each of the secured endpoints, the authorization server providing credentials to authenticated secured endpoints associated with one or more of the communities of interest defined using the management service.

This summary is provided to introduce a selection of concepts in a simplified form that are farther described below in the Detailed Description. This summary is not intended to identify key features or essential features of the claimed subject matter, nor is it intended to be used to limit the scope of the claimed subject matter.

### BRIEF DESCRIPTION OF TUE DRAWINGS

FIG. 1 illustrates a schematic view of an enterprise network distributed across premises, representing an example network in which aspects of the present disclosure can be implemented;

FIG. 2 illustrates an example enterprise management system useable within the enterprise network of FIG. 1;

FIG. 3 illustrates an example data model for enterprise management settings in a configuration database, according to an example embodiment of the present disclosure;

FIG. 4 illustrates a distributed multi-host system in which aspects of the present disclosure can be implemented;

FIG. 5 illustrates an example block diagram of a host computing system within the system of FIG. 4;

FIG. 6 is a flowchart of an example method of managing a secure enterprise, according to an example embodiment of the present disclosure;

FIG. 7 is a flowchart of an example method of configuring a management server useable within the enterprise management system discussed herein;

FIG. 8 is a flowchart of an example method of configuring an authorization server useable within the enterprise management system discussed herein;

FIG. 9 is a flowchart of an example method of configuring secure appliance useable within the enterprise management system discussed herein;

FIG. 10 is a flowchart of an example method of configuring a gateway useable within the enterprise management system discussed herein;

FIG. 11 is a flowchart of an example method of configuring an endpoint useable within the enterprise management system discussed herein; and

FIG. 12 is a flowchart of an example method of administratively managing an enterprise via a management server, according to an example aspect of the present disclosure.

### DETAILED DESCRIPTION

As briefly described above, embodiments of the present invention are directed to a secure communications system, and in particular to an enterprise management system for secure network communications, such as over IPsec. In various embodiments discussed herein, an enterprise management system is provided that allows for remote access to a centralized management system for securely configuring and provisioning an enterprise network, including management of security credentials, licenses, and centralized user and endpoint management Additionally, the enterprise management system is configurable to be redundant, distributable across multiple different computing systems across an enterprise, and can incorporate use of security appliances in a mixed-use enterprise in which endpoints at different enterprise premises may securely communicate or may use security appliances for such communication.

In addition, in certain aspects of the present disclosure, a web interface configurable to provide administrative access at a variety of access levels is provided in which a portal, constructed from a plurality of configurable portlets, can be delivered to a web interface. Additionally, the web interface allows an administrative user to configure the enterprise. A configuration database having a universal data model allows for such centralized access to enterprise configuration data, and is operable in conjunction with licensing and authentication servers to manage and log accesses of various enterprise resources, thereby simplifying enterprise management across an enterprise having a plurality of different locations or premises. In certain aspects, the present disclosure relates to use of Stealth secure data and communications technologies provided by Unisys Corporation of Blue Bell, Pa.

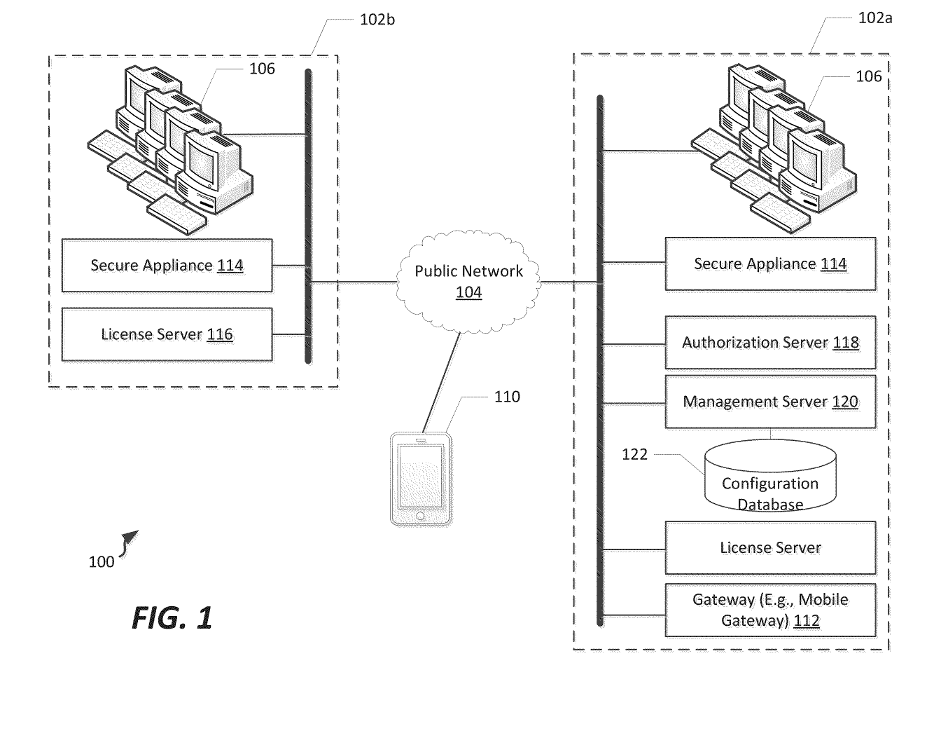

Referring now to FIG. 1, a schematic view of an enterprise network 100 is illustrated. The enterprise network 100 is distributed across premises, and therefore includes at least a first premises 102a and a second premises 102b separated by a network 104, which can in some cases represent an at least partially public network, such as the Internet. The enterprise network 100 includes a plurality of endpoints 106. The endpoints 106 can be, for example, servers or workstations operable or accessible by a user to perform various tasks germane to the enterprise.

Users of such endpoints in this context may be associated with the enterprise and may be afforded access to computing resources at the endpoints 106; in such cases, different users may have different access rights to data or resources included in the enterprise. Accordingly, users are, via a management system, separated into defined communities of interest (COIs) which allows for common access rights to a group of users. The common access rights may be, in a corporate context, access rights associated with a particular department or project; in other contexts, access rights may be defined by a particular security clearance, membership in a particular group, or having a particular interest in common data or applications.

In the embodiment shown, each of the premises 102a-b have a plurality of endpoints 106 located within the premises. In such arrangements, the endpoints 106 can be interconnected at each of the premises using standard communications equipment (not shown) such as routers, switches, and cabling. In some embodiments, the endpoints 106 can be virtualized endpoints maintained on one or more servers. In such cases, one possible implementation of such an arrangement could be provided using S-Par Secure Partitioning platform provided by Unisys Corporation of Blue Bell, Pa. Other virtualization systems could be used as well.

It is noted that, in addition to endpoints 106 at premises 102a-b, other access mechanisms to the enterprise network 100 may be desirable as well. For example, in the embodiment shown a mobile device 110 may be used to access data or computing resources of the enterprise. In some embodiments, the mobile device 110 can establish a secure connection with a mobile gateway, such as gateway 112 which can act as a proxy for the mobile device 110 within the network, including receiving access to other endpoints within the network based on a community of interest of the user associated with the mobile device 110.

Referring to the premises 102a-b generally, it is noted that in the embodiment shown, each premises may include a secure appliance 114. The secure appliance can manage secure communications among endpoints 106 or between premises 102a-b. In example embodiments, the secure appliance 114 can be used to deliver encryption keys or encryption features (e.g., a driver with which endpoints can secure data for communication) for endpoints. In alternative embodiments, the secure appliance 114 may not be needed by some or all endpoints; in such arrangements, a native security feature, such as IPsec, could be used by the endpoints to ensure security within a premises 102, or between premises 102a-b generally. In such cases, encryption keys and standards can be defined centrally, for example using the management server described herein, to establish different keys and different communities of interest for use by the authorized users of endpoints across the premises 102a-b.

Additionally, in the embodiment shown, one or both premises 102a-b can include a license server 116. The license server 116 can manage and track license usage by the endpoints 106. For example one or more endpoints 106 may request a license to particular software or to a particular network resource. In such cases, the license server 116 can be contacted to grant or deny a license to such software or resource, based on a number of licenses available and whether the user of the endpoint is authorized to use such software or resource.

Additionally, in the embodiment shown, an authorization server 118 can be provided at one or more of the premises 102. The authorization server 118 can be accessed by an endpoint that is seeking authorization to access other resources within the network. Generally, the authorization server 118 can establish a secure communication session with that endpoint to provide authorization information (keys, settings, COI filters, etc.) to allow that endpoint to communicate with other endpoints within the network.

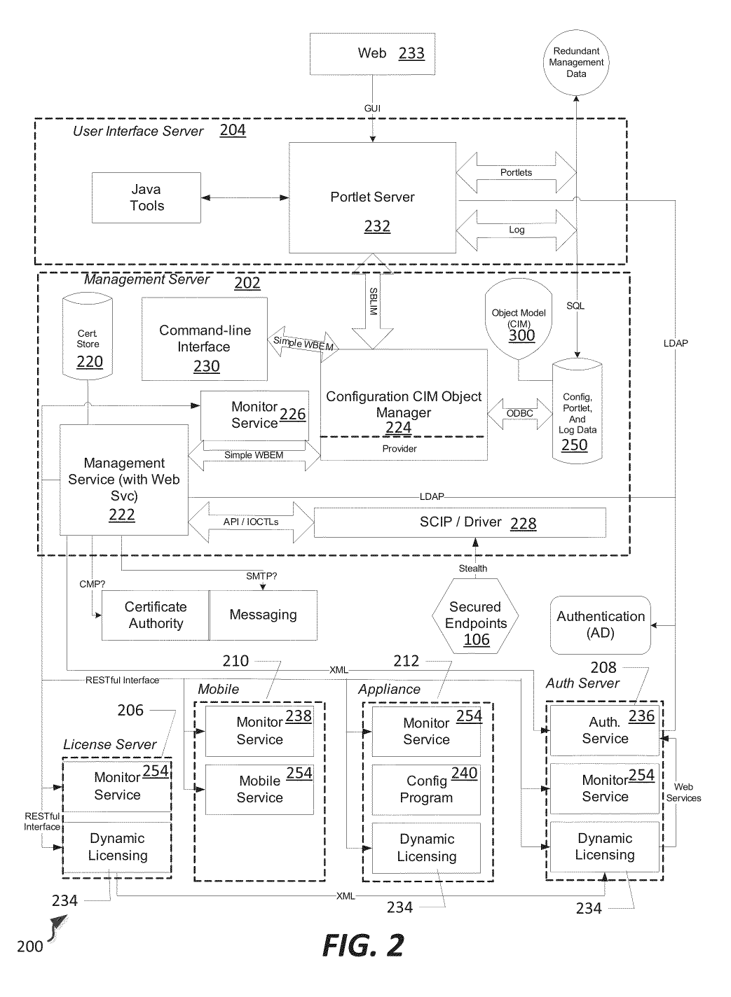

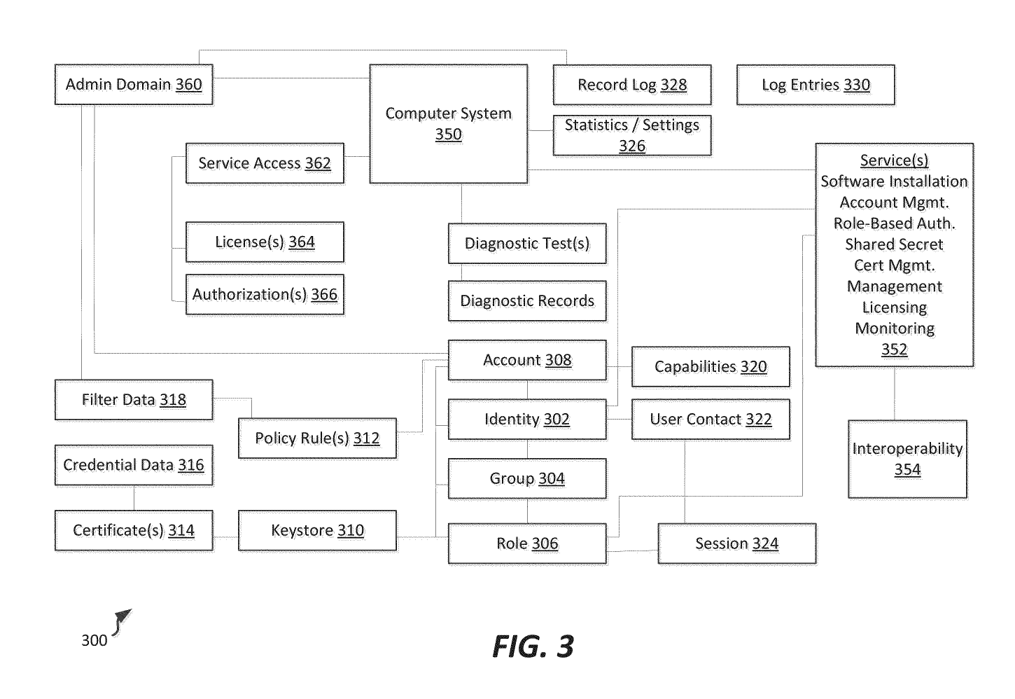

In addition to the above, although in some prior versions management of configuration settings are managed locally at a secure appliance, in the present application a management server 120 is located at one of the premises 102a-b. The management server 120 provides a universally-accessible access location at which management settings can be viewed, enterprise access attempts logged, license tracking can be managed, and security arrangements defined, including definition of encryption policies, communities of interest, enterprise resources available, and other features as discussed further below in connection with FIGS. 2-3.

Generally, the management server 120 is communicatively connected to a configuration database 122 (e.g., by hosting the configuration database or being communicatively connected to a separate computing system or systems that host that database). The configuration database generally stores configuration settings included in one or more configuration profiles for the enterprise network; and one or more interface definitions useable by the web interface to provide administrative access to the configuration settings. Details regarding additional features stored in the configuration database are discussed below in connection with FIG. 3.

Enterprise management within the enterprise network 100 can be distributed among one or more of the management server 120, authorization server 118, license server 116, and secure appliance 114. Enterprise management provides the general management and control for servers using the Stealth security features of an enterprise network, and in particular Stealth installations that apply IPsec-based security. Each enterprise network, or enclave, can have a management instance that performs various user authentication, logging, licensing, certificate management, administration, web services, and software update features. Regarding authorization, the management service can ensure that a user is authenticated and authorized when logging on to the endpoint 106. The endpoint 106 receives an Authorization Token (AuthToken) that identifies the user's COI membership status.

The management server 120 hosts a management service that can also receive log information to be recorded, and can issue commands to the server to control its behavior or to request status information. This includes retrieving debugging information regarding security software installed through the enterprise. The management service also controls licensing, for example by installing a license System Control Number (SCN) and license values (strings) on a license host, such as either the management server 120 or the authorization server 118. Remote authorization servers, such as authorization server 118, communicate with a license host to share its licenses. The management service also performs certificate management to maintain the certificates used for authentication. This may include an interface to an outside certificate authority, as discussed further in connection with FIG. 2, below.

Administrative users of the system 100 will use a GUI to control account management, role-based authorization, certificate management, and other administrative tasks. A scripting interface also is provided to perform these tasks; details regarding implementation of such a GUI are discussed further below in connection with FIG. 2. In some embodiments, a web services interface is provided to allow network access to management services. Additionally, the enterprise management features of the present disclosure are configurable to inventory levels of installed software and provide for software updates. This may include updates for endpoints as well as the management service itself.

In general, although the enterprise network 100 as shown is disclosed as having a plurality of premises 102a-b and a single management server 120, it is noted that other arrangements may exist in which management servers 120 can be distributed at one or more distributed locations, each of which are configured to communicate with an instance of the configuration database 122. Furthermore, one or more of those management servers 120 can be maintained as a redundant management server that is accessed in the event of failure of a primary management server. Additionally, since the management server 120 can be, in some embodiments, implemented as a process that executes within a computing environment, functionality of the management server can be combined with that of other systems on a single computing system or separated onto different computing systems; in some embodiments, a user interface server, management server, authorization server, license server, and/or other enterprise network security services can be located on separate servers, while in other embodiments two or more of these services can be combined on a single device (e.g., a discrete physical computing device or a virtual computing device installed on a partition of a physical computing device).

Referring now to FIG. 2, a block diagram illustrating an example enterprise management system 200 useable within the enterprise network 100 of FIG. 1 is shown. The enterprise management system 200 can be, for example, implemented using one or more of the management server 120, authorization server 118, license server 116, or secure appliance 114.

In the embodiment shown, the enterprise management system 200 includes a management server 202, a user interface server 204, a license server 206, an authorization server 208, a mobile server 210, and an appliance server 212.

The management server 202 includes a key store 220. The key store contains material used to distinguish individual communities-of-interest (COIs). This material may be certificates or individual keys. The key store 220 may be installed on a separate, trusted system. The key store 220 can include several parts, such as a certificate store and a credential store. The configuration database is also a key store. In some embodiments, the key store can be moved to a system remote from the management server 202, and can be accessed via a third party communication interface.

The management server 202 also hosts a configuration database 250. The configuration database is, in the embodiment shown, a SQL-based database containing configuration and display information. The configuration information can include, for example, both administrator created items and system information discovered by a management service. This information can be stored in the configuration database 250 using an object model based upon the Common Information Model (CIM) standard. The object model is based upon a collection of profiles created as part of that standard. In some embodiments, the Pegasus Object Manager is used to interface to this data.

The display information in the configuration database 250 is used to support an administrator graphical user interface (GUI). A portlet server software package, discussed further below, is used to display the GUI. The portlet server defines portlets that describe the web interface pages displayed to administrators. The portlets retrieve information from the object model to create the GUI pages. The portlets themselves are also stored in the configuration database 250. The portlets can include, for example, an administrative portlet, a monitoring portlet, a configuration portlet, a logging portlet, an alerts portlet, a software installation portlet, a jobs portlet, a provisioning portlet, a filters portlet, and a locking portlet. Other portlets may be included as well; furthermore, portlets accessible to the user may vary depending on the administrative rights of the user, as explained below.

The management server 202 includes a management service 222. The management service 222 is intended to automatically be initiated when the management server is booted, and examines the configuration database 250. The management service 222 can also, in some embodiments, initialize a secure communications protocol (SCIP) useable to implement the Stealth security technology, and coordinates with a database manager of the configuration database.

In some embodiments, the management service 222 provides a web interface that handles direct requests concerning status of an enterprise network. The web interface presents one or more different customized interface presentations, with different authentication requirements. In some cases, the management service 222 can present different external and internal interfaces, depending on whether the request is received from within or external to the enterprise network. The management service 222 provides functions to perform administrative tasks, as requested through the web interface. The tasks can include, for example, configuration of user roles and associated COI memberships and privileges, certificate management, and monitoring of status. The management service 222 updates the configuration database to reflect current configuration information.

In some embodiments, the management service 222 also maintains log information, and records management functions that are requested, for potential future audits, Low, information can be received via SCIP, and saved in the configuration database 250. A syslog interface can also be provided for forwarding of Ice information.

In view of use of the management service 222, a migration path from prior versions of Stealth installations can be provided, for example based on a generation of XML-based output from a provisioning utility that generates certificates that can be exported to a secure appliance (e.g., appliance 114), which in prior versions of Stealth installations managed COI memberships. Such secure appliances can use the certificates to export COIs generated and managed in such appliances to the management server 202, for storage in the configuration database 250. Certificates can be communicated via CMP, or some other communication interface. An external certificate authority 223 can be used as well.

In some example embodiments, the management service 222 can also allow administrators to register to be notified in the event of alerts. Alerts can be saved in a message log.

The management server 202 further includes a configuration object manager 224, also referred to herein as CIMOM 224. In various embodiments, the CIMOM 224 manages the configuration database 250. In such embodiments, the CIMOM 4 is configured with a set of classes that describe an object model used for the configuration database 250, discussed further below in connection with FIG. 3, as well as a set of interfaces to the data.

The CIMOM 224 manages the configuration database 250 in a SQL database format, and can further synchronize management servers to provide redundancy. In such embodiments, data exchange can be provided using a special purpose secured community of interest, such as a “management” COI that is used only by database servers 202. Furthermore, in some embodiments, a provider driver is provided on the management server 202 and provided to the CIMOM 224 for handling: of configuration functions or dynamic classes; in such cases, the CIMOM 224 can call the provider driver to handle such features. The CIMOM 224 can connect to the configuration database via an ODBC-based interface.

The management server 202 further includes a monitor service 226 that transmits the state of the server 202 to the management service 222, which stores that state in the configuration database 250. The monitor service 226 performs administrative tasks as received via portlets, such as starting and stopping of security/Stealth functions.

The management server 202 also includes a secure communications interface protocol (SCIP) service 228. SCIP provides functionality to endpoints to perform secure communications within a Stealth-enabled network. The SCIP service 228 will identify itself as running on the management server 202, and activates an interface that allows SCIP to request management functions to handle Stealth-based features, such as registration of endpoints, user authentication, and logging of messages. Interfaces supplied by SCIP service 228 can include, for example, a registration interface allowing devices to register themselves, a logon interface to allow an authorization client to interface with native authentication, an authorization agent, a filter interface, and an administration agent that monitors and controls endpoints. The SCIP service 228 can communicate via an IPSec-based interface. The management server 202 also includes a command line interface 230 that provides a scripting mechanism for administration and debugging.

In the embodiment shown, the user interface server 204 includes a portal manager, referred to herein as portlet server 232. The portlet server 232 hosts web pages accessible via the web 233, that are defined using the portlet server; the portlet server can request such user interface data from the CIMOM 224, which is then accessed from the configuration database 250 via the management service 222. In example embodiments, portlets generated by the portlet server 232 are formatting using a tree-oriented explorer view, and can include a main body, a mechanism for reporting job status and messages, and links to other portlets. The user interface server 204 authenticates administrative users based on their role; roles can include a portal administrator, a Stealth administrator (managing policy and diagnostic requests), a crypto administrator (managing accounts, roles, COIs, and filters) and an audit administrator. Other administrative roles can be defined as well. Changes made by administrators can be logged by reporting to the management service 222 of the management server 202 as well. It is noted that portlets, the log information, and configuration data from the configuration database 250 can be stored in redundant storage 252, as illustrated,

The portlet server 232 generates web interfaces that are accessible from the user interface server 204 via a secured HTTP interface (e.g., HTTPS).

The license server 206 includes a dynamic licensing module 234 that reads a license file to acquire license parameters and store results in the configuration database. The dynamic licensing module 232 interfaces with an authorization service 236 to verify that license parameters are not exceeded, and to provide license status. The dynamic licensing module 234 coordinates with licensing servers via an XML-based interface, and provides a web interface for other services to request or change license information. In example embodiments, licenses can be provided through a license tile. A file would contain the licenses in encrypted form, and control a number of simultaneous active users in various configurations.

In some embodiments, a customer will request a system control number (SCN) that is unique to a system; that SCN will be used to generate a certificate with a public/private key pair. The license file, storing the certificate, can be maintained on the management server 202, a license server 206, or an authorization server 208. Licenses are provided to an authorization service (e.g., authorization service 236, below) through a web interface and to another license service using a socket-based interface.

The license service, provided by the dynamic licensing module 234, tracks incoming requests for licenses and compares the total requested to the number available. The licenses are granted if available. Different actions may be taken if not available, based on license type. If the license file is not installed on a system running the dynamic licensing module 234, the service will search for licenses when it starts. Each provisioned configuration contains list of license servers and authorization servers. These lists are provided to the endpoint in its installation package. The dynamic licensing module 234 searches the lists until it finds a system that has licenses installed. It searches the list of license servers first, and then the list of authorization servers. It stops when it finds a providing system regardless of the number of licenses that system has available. If no providing system can be found, or contact is lost with a providing system, the License service starts a grace period. It provides licenses locally, based upon its last contact with a providing system, until the end of the grace period. It stops providing licenses at the end of the grace period. Installed licenses may be removed from a system by request. A return receipt is generated, and the licenses deallocated. If a user or customer moves to a new system, that customer must request a new SCN and initiate the process on the new machine,

The authorization server 208 includes an authorization service 236 that manages community of interest information. Stealth-enabled endpoints maintain a licensing/logging tunnel to the authorization services 234.

The mobile server 210 includes a mobile service 238 that operates as a broker for mobile devices communicatively connected to the enterprise. The mobile service 238 can act as a gateway for mobile devices to access resources within the network. Details regarding implementation of a mobile gateway are provided in copending U.S. Patent Application No. ______, entitled “Secure Network Communications in a Mobile Device Over IPSec”. (Docket No. TN624P) the disclosure of which is hereby incorporated by reference in its entirety.

The appliance server 212 provides a config program 240 that allows for using a secure appliance useable in backwards-compatible installations of a Stealth-secured network, Such functionality is described in the above-listed patent applications, previously incorporated by reference in their entireties. In addition to the above, each of the license server 206, authorization server 208, mobile server 210. and appliance server 212 can execute a monitor service 254, analogous to monitor service 226. Additionally, the various services can communicate using SSL-protected communications, for example using a RESTful HTTPS interface.

FIG. 3 illustrates an example data model 300 for enterprise management settings in a configuration database 250, according to an example embodiment of the present disclosure. The data model 300 defines a format of the configuration information saved in the configuration database 250. In the embodiment shown, it is based upon the Common Information Model (CIM) and includes profiles defined by the Distributed Management Task Force (DMTF). One or more profiles can be included as part of the data model 300, such as: (1) A Simple Identity Management profile used to identify accounts and how they are used to establish authorized identities; (2) a Role-Based Authorization profile used to establish roles and specify privileges for those roles; (3) a Certificate Management profile used for the handling of certificates and how they relate to roles and COIs; (4) a Job Control profile used to define how jobs that perform management services are handled; and (5) an indications profile used to define how indications are handled when an event occurs. Other profiles, such as a profile registration, software inventory, software update, policy, diagnostics, and record log profile could be used as well.

In general and as illustrated in FIG. 3, the data model 300 provides typical profiles such as an identity profile 302, a group profile 304, and a role profile 306 each associated with an account table 308. The information defining these profiles is on the left of the figure, such as the keystore 310, policy rules 312, certificates 314, credential data 316, and filter data 318, infrastructure information used by the Job, Indication, and Registration profiles is on the right of the figure, such as the capabilities data 320, user contact data 322, session data 324, statistics/settings 326, a record log 328, and log entries 330, associated with a computing system 350 that is defined in the data model 300. It is noted that various data stored in the data model 300, and in particular sensitive information such as certificates 314, credential data 316, and keys stored in the keystore 310 can be stored in an encrypted format. Various encryption techniques can be used, including a Stealth-based Data at Rest storage model in which particular users have access to such data, as is described in the above-referenced patent applications, previously incorporated by reference.

There can be multiple instances of a service 352 defined in the data model 300. There is one for every system that has it installed. For example, for the license service provided by the dynamic licensing module 234, that means there would be an instance for the management server 202 and for every authorization server 208. Additionally, the services 352 can be accessed via interoperability interfaces 354 defined in the data model.

The computing system 350 can also have associated therewith a set of access rights, including administrative domain rights 360, as well as service access rights 362, as well as licenses 364 and authorizations 366.

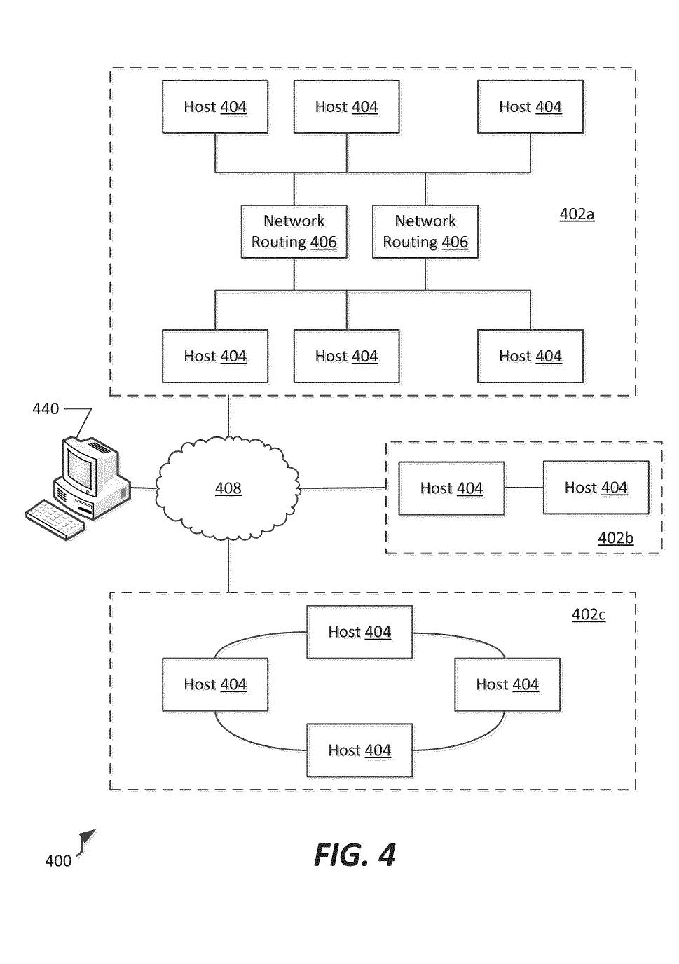

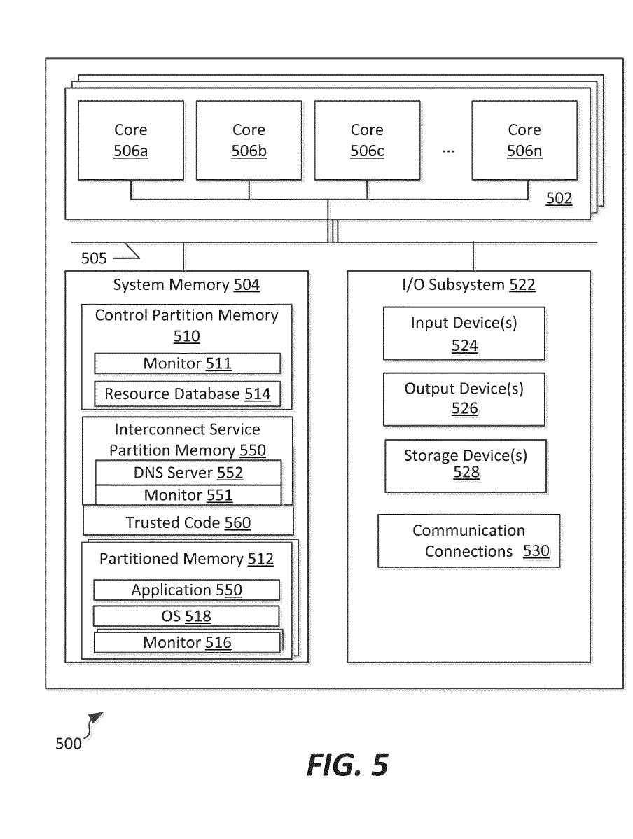

Referring now to FIGS. 4-5, example arrangements of computing resources are illustrated for implementing the enterprise network described in FIGS. 1-3, above. The computing resources in the example shown represent an arrangement in which native or virtualized computing solutions can be provided to an enterprise across a plurality of enterprise locations. Example types of installations such as those depicted can utilize virtualization software systems, such as the S-Par secure partitioning and virtualization system provided by Unisys Corporation of Blue Bell, Pa.

As illustrated in FIG. 4, a system 400 in which the para-virtualization systems of the present disclosure can be implemented is shown. The system 400 is, in the embodiment shown, distributed across one or more locations 402, shown as locations 402a-c. These can correspond to locations remote from each other, such as a data center owned or controlled by an organization, a third-party managed computing cluster used in a “cloud” computing arrangement, or other local or remote computing resources residing within a trusted grouping. In the embodiment shown, the locations 402a-c each include one or more host systems 404. The host systems 404 represent host computing systems, and can take any of a number of forms. For example, the host systems 404 can be server computing systems having one or more processing cores and memory subsystems and are useable for large-scale computing tasks. In one example embodiment, a host system 404 can be as illustrated in FIG. 5.

As illustrated in FIG. 4, a location 402 within the system 400 can be organized in a variety of ways. In the embodiment shown, a first location 402a includes network routing equipment 406, which routes communication traffic among the various hosts 404, for example in a switched network configuration. Second location 402b illustrates a peer-to-peer arrangement of host systems. Third location 402c illustrates a ring arrangement in which messages and/or data can be passed among the host computing systems themselves, which provide the routing of messages. Other types of networked arrangements could be used as well.

In various embodiments, at each location 402, the host systems 404 are interconnected by a high-speed, high-bandwidth interconnect, thereby minimizing latency due to data transfers between host systems. In an example embodiment, the interconnect can be provided by an Infiniband switched fabric communications link; in alternative embodiments, other types of interconnect technologies, such as Fibre Channel, PCI Express, Serial ATA, or other interconnect could be used as well.

Among the locations 402a-c, a variety of communication technologies can also be used to provide communicative connections of host systems 404 at different locations. For example, a packet-switched networking arrangement, such as via the Internet 408, could be used. Preferably, the interconnections among locations 402a-c are provided on a high-bandwidth connection, such as a fiber Optic communication connection.

In the embodiment shown, the various host system 404 at locations 402a-c can be accessed by a client computing system 410 such as the endpoints 106 of FIG. 1. The client computing system can be any of a variety of desktop or mobile computing systems, such as a desktop, laptop, tablet, smartphone, or other type of user computing system, in alternative embodiments, the client computing system 410 can correspond to a server not forming a cooperative part of the para-virtualization system described herein, but rather which accesses data hosted on such a system. It is of course noted that various virtualized partitions within a para-virtualization system could also host applications accessible to a user and correspond to client systems as well.

It is noted that, in various embodiments, different arrangements of host systems 404 within the overall system 400 can be used; for example, different host systems 404 may have different numbers or types of processing cores, and different capacity and type of memory and/or caching subsystems could be implemented in different ones of the host system 404. Furthermore, one or more different types of communicative interconnect technologies might be used in the different locations 402a-c, or within a particular location.

Referring to FIG. 5, an example block diagram of a host computing system 200 useable to implement the enterprise management systems of FIGS. 1-3, is shown. The host computing system 500 can, in some embodiments, represent an example of a host system 404 of FIG. 4, useable within the system 400, to execute either native or virtualized computing environments. The host computing system 500 includes one or more processing subsystems 502, communicatively connected to a system memory 504. Each processing subsystem 502 can include one or more processing cores 206, shown as processing cores 506a-n. Each processing core can, in various embodiments, include one or more physical or logical processing units capable of executing computer-readable instructions. In example embodiments, the processing cores 506a-n can be implemented using any of a variety of x86 instruction sets, such as x86, x86-64, or IA64 instruction set architectures. In alternative embodiments, other instruction set architectures, such as ARM, MIPS, Power, SPARC, or other types of computing set architectures could be used.

In addition, each of the processing subsystems 502 can include one or more card-based processing subsystems including a plurality of sockets for supporting execution cores 506a-n, or alternatively can support a socket-based or mounted arrangement in which one or more execution cores are included on a single die to be mounted within the host computing system 500. Furthermore, in the embodiment shown, a plurality of processing subsystems 502 can be included in the host computing system, thereby providing a system in which one or more cores could be allocated to different partitions hosted by the same computing hardware; in alternative embodiments, a single processing subsystem including one or more processing cores 506a-n could be included in the host computing system 500, and that processing subsystem 502 could be implemented without separation from system memory 204 by a card-based implementation.

As illustrated, the system memory 504 is communicatively interconnected to the one or more processing subsystems 502 by way of a system bus 505. The system bus is largely dependent upon the architecture and memory speed support of the processing subsystems with which it is implemented; although example systems provide different frequencies and throughputs of such system buses, in general the bus system between processing subsystems 502 and the system memory is a low-latency, high bandwidth connection useable to rapidly retrieve data from the system memory 504. System memory 204 includes one or more computer storage media capable of storing data and/or instructions in a manner that provides for quick retrieval of such data and/or instructions by a corresponding processing core 506. In different embodiments, the system memory 504 is implemented in different ways. For example, the memory 504 can be implemented using various types of computer storage media.

In the embodiment shown, system memory 504 can be allocated to one or more partitions using the software described herein. In the example illustration shown, sub-sections of the system memory 504 can be allocated to a control partition section 510 and one or more memory partitions 512. The control partition section 510 includes a monitor 511. The control partition section 510 can also include a resource database 214 that tracks resources allocated to other partitions within the host computing system 200. This can include, for example, a listing of execution cores 506, capacity and location of system memory 504, as well as I/O devices or other types of devices associated with each partition.

In the embodiment shown, the system memory 504 includes memory partitions 512 which each are associated with different partitions formed within a host computing system 500. The memory partitions 512 can, in the embodiment shown, each include a monitor 516, an associated operating system 518, and one or more applications or workloads 520 to be executed within the partition. Since each memory partition 512 can be associated with one or more execution cores 506 in the resource database 514, the assigned execution cores can be used to access and execute the monitor software 516 as well as the operating system 518 and workloads 520.

It is noted that in some embodiments, the partition 512 may include multiple instances of the monitor software 516. This may be the case, for example, for partitions that have allocated thereto more than one execution core. For such cases, monitor software 216 may be allocated, for and used with each execution core. Therefore, there may be more than one such monitor executing per partition, with each monitor handling various I/O, memory, or interrupt servicing tasks that may be issued with respect to that particular execution core. Each monitor supervises execution of software within a partition as allocated to a particular execution n core; accordingly, if a single partition has multiple execution cores, the operating system 518 may allocate execution of operating system tasks, or the workload(s) 520, to one or both of the execution cores. The host computing device includes an I/O subsystem 522 that includes one or more input devices 524, output devices 526, and storage devices 528. The input devices 524 can include, for example, a keyboard, a mouse, a pen, a sound input device, a touch input device, etc. Output device(s) 526 can include, for example, a display, speakers, a printer, etc. The aforementioned devices are examples and others may be used. Storage devices 528 store data and software instructions not directly accessible by the processing subsystems 502. In other words, the processing subsystems 502 perform an I/O operation to retrieve data and/or software instructions from the storage device 528. In various embodiments, the secondary storage device 528 includes various types of computer storage media. For example, the secondary storage device 528 can include one or more magnetic disks, magnetic tape drives, optical discs, solid state memory devices, and/or other types of computer storage media.

The I/O subsystem 522 further includes one or more communication connections 530. The communication connections 530 enable the computing device 500 to send data to and receive data from a network of one or more such devices. In different embodiments, the communication connections can be implemented in different ways. For example, the communications connections can include a network interface card implementing an Ethernet interface, a token-ring network interface, a fiber optic network interface, a wireless network interface (e.g., Wi-Fi, WiMax, etc.), or another type of network interface. The communication connections 232 can also include an inter-system communication connection for direct data communication between computing systems, such as a Infiniband switched fabric communications link, or a Fibre Channel, PCI Express, Serial ATA, or other type of direct data communication link.

As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, DDR4 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Computer storage media generally includes at least some tangible, non-transitory media and can, in some embodiments, exclude transitory wired or wireless signals. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RE), infrared, and other wireless media. In accordance with the present disclosure, the term computer readable media as used herein may include computer storage media, but generally excludes entirely transitory embodiments of communication media, such as modulated data signals.

Furthermore, embodiments of the present disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIGS. 4-5 may be integrated onto a single integrated circuit. Such an SOC device may include one or more processing units, graphics units, communications units, system virtualization units and various application functionality all of which are integrated “burned”) onto the chip substrate as a single integrated circuit. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Although particular features are discussed herein as included within a host computing system 500, it is recognized that in certain embodiments not all such components or features may be included within a computing device executing according to the methods and systems of the present disclosure. Furthermore, different types of hardware and/or software systems could be incorporated into such an electronic computing device.

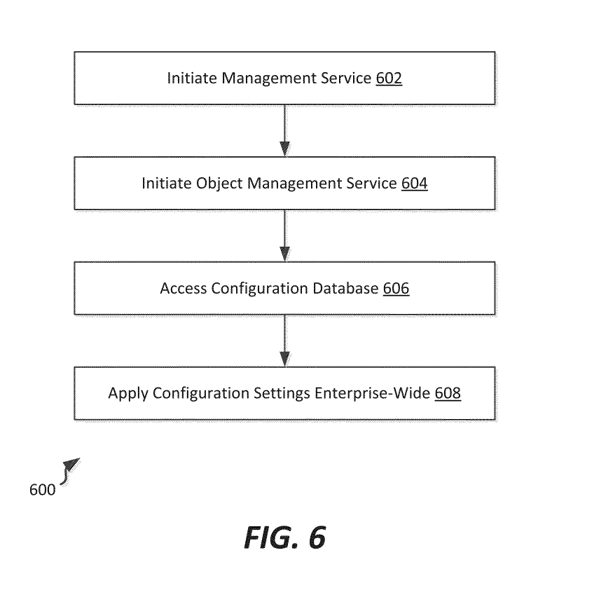

Referring now to FIGS. 6-12, flowcharts illustrating installation, configuration, and operation of an enterprise management system are shown, according to example embodiments of the present disclosure. The flowcharts illustrate methods by which an enterprise network can be managed, and how such a management service can be instantiated and used by administrative users within a secured network such as the Stealth-based networks discussed above.

FIG. 6 is a flowchart of an example method 600 of managing a secure enterprise, according to an example embodiment of the present disclosure. The method 600 can correspond, for example, to overall management from a server that is configurable to track and control security settings and enterprise management across a multi-premises enterprise In the embodiment shown, the method 600 includes initiating a management service (step 602) at a server within the secure enterprise. The management service can be, for example, management service 222 operable on the management server 202 of FIG. 2, above. The management service includes a web interface providing administrative access to configuration settings associated with the secure enterprise. The management service further initializes a secure communications protocol and manages access to a credential store. The credential store includes a plurality of credentials defining communities of interest within the secure enterprise, each of the communities of interest defining a collection of authenticated endpoints having common access and usage rights.

In the embodiment shown, the method 600 further includes initiating an object management service at the server (step 604). The object management service can be, for example, CIMOM 224, and can be configured to define an interface to a configuration database, such as configuration database 250. As noted above, the configuration database can store configuration settings included in one or more configuration profiles for the enterprise network, as well as one or more interface definitions (e.g., portlets) useable by the web interface to provide administrative access to the configuration settings.

The method can further include accessing, via the object management service, the configuration database (step 606) to obtain data defining a configuration of the enterprise according to a configuration profile, as well as applying one or more configuration settings to the secure enterprise (step 608) based on the data defining the configuration of the secure enterprise. Accordingly, method 600 allows for centralized control and management of enterprise security definitions, while providing both a convenient administrative access location and backward compatibility to previous, distributed enterprise management schemes,

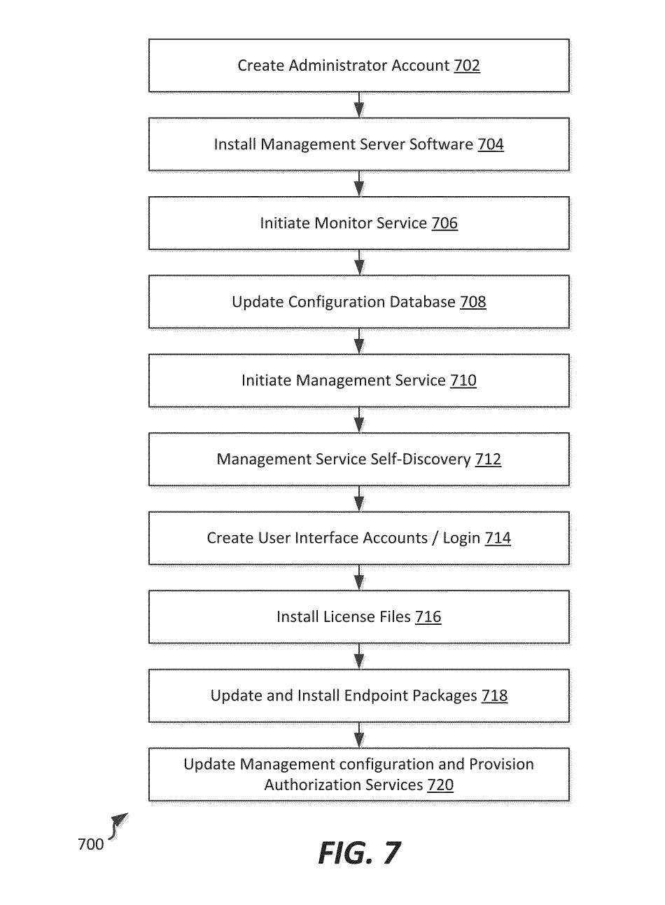

Referring now to FIG. 7, a flowchart of an example method 700 of configuring a management server useable within the enterprise management system is shown. Generally, the method 700 can be performed after a management server, such as server 202 of FIG. 2, is instantiated. Generally, an administrator account is created (step 702) for management; in such circumstances, a management certificate can be installed as well. The management server software is installed (step 704) from an installation file, and an administrator account is specified to be used by the configuration database 250, as well as the portlet server and management service. The administrator account is used to limit access to configuration information to the specified administrator account.

The method 700 includes starting a monitor service (step 706), such as monitor service 226 of FIG. 2. The monitor service 226 examines the state of the system and installed Stealth-based services, to retrieve a status and setting values associated with those services. The configuration database 250 is then updated (step 708) to limit access to the administrator account previously created.

In the embodiment shown, the method 700 further includes initiating the management service (step 710), e.g., service 222 of FIG. 2. The management service connects to the configuration database 250. Once connected, the management service performs a self-discovery process (step 712). This includes, in various embodiments, connecting to the monitor service to retrieve status and system values, as well as accessing a record of the computing system in the database registered as the management system. A certificate can be located or generated, and status and setting values updated. The self-discovery process can further include logging each last reported event and scanning for new endpoint packages stored in the configuration database for distribution as may be needed. Additionally, a discovery job is initiated, and a default management configuration built, including an identity based on the administrator account, roles for management and authorization, and a management COI useable for such roles.

In the embodiment shown, the method 700 can further include creation of user interface accounts and logging in to the user interface (step 714). This can include updates to management system settings as well. A license file is installed, at the management server (step 716) and endpoint packages updated if needed (step 718).

At this stage in the method 700, management configurations are updated and authorization services are provisioned (step 720). Exact steps to accomplish such tasks may depend on the particular arrangement or enterprise in which the management service is installed. For example, if the management server 202 is used without a Stealth appliance or preexisting Stealth systems, an endpoint installation file is generated and copied to the management server for installation via a portlet. If the management server is to be used in conjunction with an existing Stealth installation, a workgroup COI is generated for use by administrators, and both the workgroup COI and management COI are exported from a device for import into the management server and configuration database. A management user role is created, authorization servers are provisioned, and the authorization service on the management server is provisioned as well.

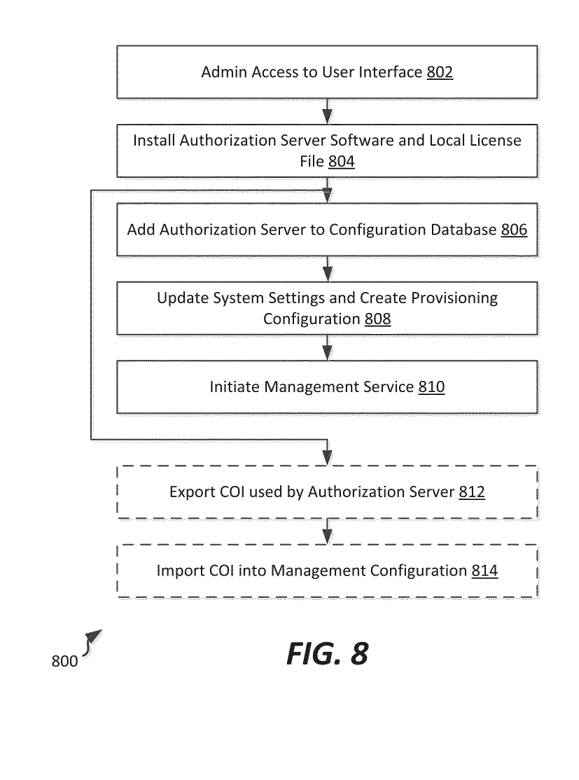

Referring now to FIG. 8, a flowchart of an example method 800 of configuring an authorization server useable within the enterprise management system is disclosed. In the embodiment shown, the method 800 includes providing administrative access to a user interface of a management system (step 802), such as one of the portlets described above in connection with FIG. 2. This can include creating an account for an authorization service to use, such as adding the authorization to an appropriate LDAP group and installing an authorization certificate with the authorization service. This can also include the administrator signing on to the portlet, with the account being added to an authorization role.

In the embodiment shown, the method 800 further includes installation of the authorization server software (step 804). This can include creating an endpoint installation file and executing that file on an authorization server to install the authorization service. The logon service is updated to use the authorization account, and contacts the authorization service operating at the management server (rather than on the authorization server) to obtain its COI information.

In the event of a first installation of the authorization server within an enterprise, the method 800 further includes adding the authorization server to the configuration database (step 806). Authorization system settings are updated as necessary and applied (step 808). Additionally, a provisioning configuration is created (or an existing one updated). The provisioning configuration includes the authorization account or group to the role for the authorization server in the configuration database. The management COI is also added to this role, alongside the authorization server, the license or management server. The authorization server is the provisioned with this configuration. The management service is then initiated (step 810).

If the authorization server is added to an existing Stealth configuration, the certificate used by the authorization server is exported to the management server (step 812), and the administrator accesses a web management interface to import that certificate into the configuration database (step 814). The authorization server is also added to the configuration database.

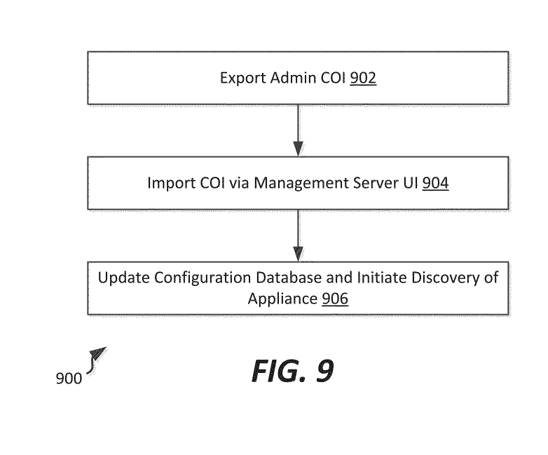

Referring now to FIG. 9, a flowchart of an example method 900 is shown of configuring a secure appliance useable within the enterprise management system. In the embodiment shown, an administrative COI used by the secure appliance is exported from the appliance to the management server (step 902). An administrative user then imports the administrative COI into the management server via a web interface of the management server (step 904), and subsequently the configuration database is updated with the administrative COI and appliance (step 906).

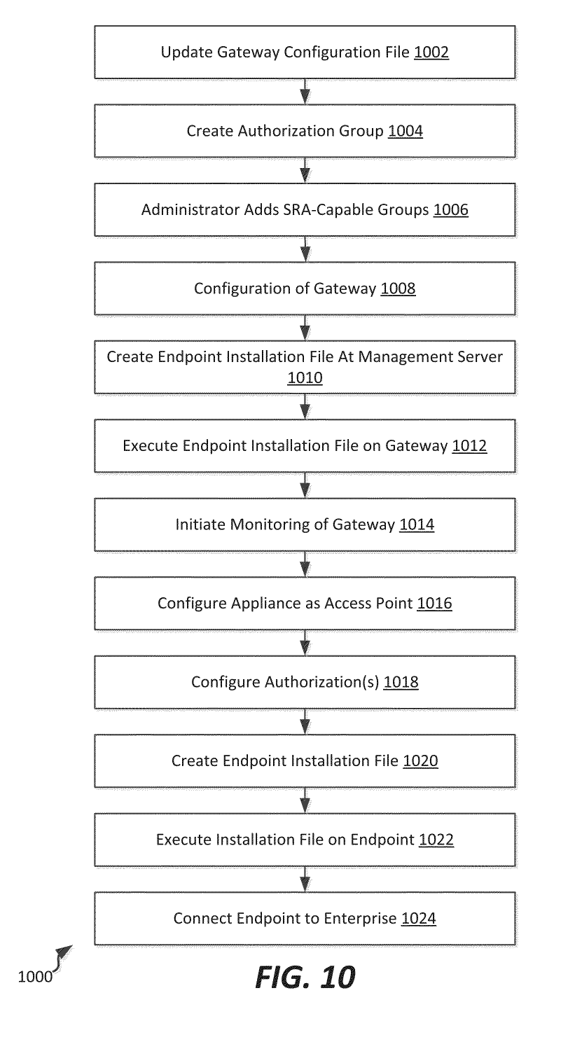

FIG. 10 is a flowchart of an example method 1000 of configuring a gateway useable within the enterprise management system discussed herein. In the embodiment shown, a gateway configuration file is updated (step 1002). The gateway configuration file describes the operation of the gateway and its virtual data relay (VDR) components, which act as proxies for remote systems (e.g., mobile systems or remote computing systems external to the enterprise, such as cloud-based systems). Authorization groups are then created on the authorization server (step 1004). Each group can include, for example, port access and usage rights.

In the embodiment shown, an administrator accesses the management service and adds SRA-capable groups to the configuration database (step 1006). This can also include creation of authorization sets. A configuration is created for the gateway (step 1008) containing a service role (and associated service COI), an authorization set for redundant COI information, and a role associated with the account to be used by the gateway. This role can include, for example, a COI that allows for contact with the management server and a COI that allows contacting the authorization server(s) hosting an authorization set.

In the embodiment shown, the method 1000 further includes creation of an endpoint installation file at the management server, for use at the gateway (step 1010). The endpoint installation file is then executed at the gateway (step 1012).

The endpoint installation file is executed on the gateway. The Logon service is updated to use the account chosen (or credentials are supplied in another fashion as designated by the endpoint configuration). The Logon service will contact the licensing Authorization service chosen to get its COI information. This is done using a separate VDR (the license VDR) assigned expressly for this purpose.

In the embodiment shown, the management server 202 begins monitoring of the gateway (step 1014). This can be in response to an administrator signing on to a user interface and initiating a management server. The administrator configures the gateway as an access point (step 1016) using an IP address and required certificate information, as well as a username and password if applicable. Additional authorizations are provided (step 1018) such as creating a configuration for use by SRA-compatible endpoints, and marking roles accessible by remote endpoints as SRA-capable. The role is also updated with a COI to be used within the enterprise, and any COIs and filters are created for use at remote locations. Additionally, one or more route tables are created for use at remote (outside premises) locations, and the role is updated with any remote filters and route tables required. The configuration is updated with authorization sets as well.

In the example shown, an endpoint installation file is created for and executed on the gateway (steps 1020, 1022), based on the configuration and mode of operation. The mode of operation specified can designate options that control the installation, including a manner of access (always vs. on demand), credential specification, ports, etc.

Once installed and initialized, the endpoint connects to the enterprise step 1024). This can include a variety of connection operations. For example, if multiple ports are configured at the gateway, a request is made by the endpoint to determine what port of the gateway is to be used. Additionally, a logon service initiates to the gateway for an endpoint connecting to the gateway if multiple remote ports are configured, a request is made to the user to identify the one desired. Service COI information can be used to initialize a license virtual data relay (VDR) and a service VDR. A license can be assigned, and remote personal information returned to an endpoint prior to termination of the service VDR.

A logon service can initiate a VPN, and a user code passed to the gateway; the gateway then sends the user code and credentials to an authorization group used when initializing the license VDR. The authorization service can perform an LDAP call for that user to obtain the user's group memberships, and the enterprise persona information is then returned to the gateway. At that time a data VDR is initiated, at the gateway using the enterprise persona, allowing the gateway to act on behalf of the endpoint to which it is connected via VPN to allow for secure access to the enterprise with proper COI memberships and security in place.

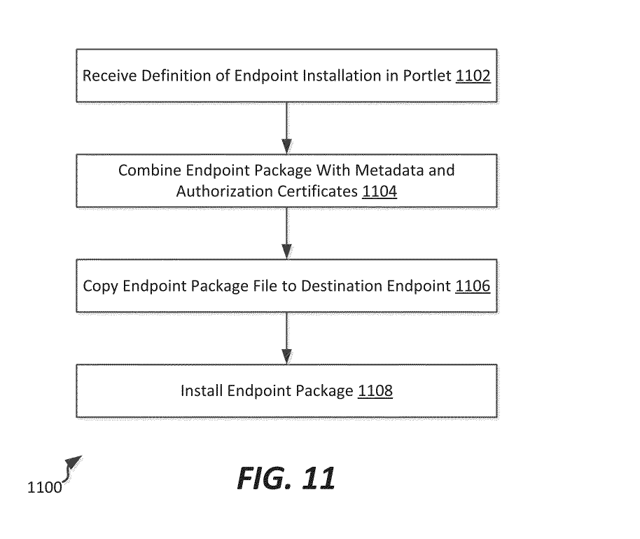

FIG. 11 is a flowchart of an example method 1100 of configuring an endpoint useable within the enterprise management system discussed herein. The method 1100 includes receiving a definition of an endpoint installation in a web interface (e.g. a portlet) from an administrative user (step 1102). The administrator specifies the endpoint package desired, the endpoint mode, and the configuration, or configurations, to use. The endpoint installation file combines the endpoint package with an XML file describing the configuration and any required authorization certificates (step 1101). The administrator can copy the installation file to the appropriate endpoint to install Stealth software (step 1106).

In some embodiments, there will be separate endpoint package files created for each type of endpoint (Windows, Red Hat, etc). Package files provided by the administrator are used to copy multiple endpoint packages onto the management server. The management server installation file will contain all the endpoint packages, so a Management Server installation also copies all the endpoint package files. The management server tracks the various endpoint packages that are available.

Various endpoint installation files may be created for different purposes. There may be different files based upon target OS, endpoint mode (e.g. enterprise server, SRA roaming workstation), configuration order (Authorization enclaves from first to last), or intended use (an SRA Gateway is limited to a single configuration). Furthermore, the endpoint package file allows for upgrade capability of an endpoint, for example to migrate endpoints to current Stealth security features remotely. Other options are available as well.

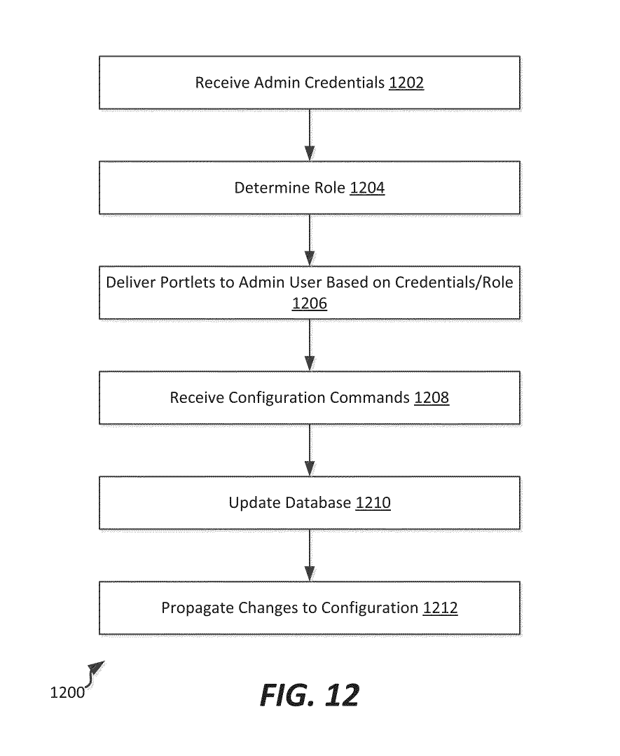

FIG. 12 is a flowchart of an example method 1200 of administratively managing an enterprise via a management server, according to an example aspect of the present disclosure. The method can be, for example, performed by a management server or generally within an enterprise management system in response to operations by an administrative user, according to example embodiments.

The method 1200 is initiated by receiving administrative credentials from a user (step 1202). The administrative credentials can identify the user as one of a variety types of administrators. The method includes determining a role of the administrator (step 1204); such roles can include, for example, a portal administrator role, a Stealth administrator role, a crypto administrator role, and/or an audit administrator role. Such roles are tracked in a configuration database, such as configuration database 250 of FIG. 2.

Based on the role determined for the user, a web interface can be presented to that user including the features accessible to the user (step 1206). The web interface can be presented to the user as one or more portlets that are selected by a portlet server component of a user interface server, such as server 206 of FIG. 2.

The web interface will receive commands from the administrative user configuring the enterprise (step 1208). These commands can vary widely based on the role of the administrative user, as well as the configuration change sought to be made. For example, configuration commands could add or edit a list of endpoints that are authorized within the enterprise, can add or edit users, can edit COI memberships, add or edit user roles, view logs or generate reports from logs, manage keys or other security settings, or otherwise set diagnostic features within the enterprise. Each of these features is generally tracked in the configuration database 250 within the data model 300 of FIG. 3. Accordingly, when such commands are received, the management server 202 (and specifically management service 222) will update the configuration database 250 accordingly (step 1210). Once the configuration database is updated, the changes made by the administrative user can also be propagated to corresponding devices within the enterprise (step 1212). This can include distributing COI or filter changes to endpoints 106 or to secure appliances 114, distributing licensing information to a licensing server, distributing COI information or user authorization information to an authorization server, or other distribution operations.

Referring to FIGS. 1-14, and referring in particular to computing systems embodying the methods and systems of the present disclosure, it is noted that various computing systems can be used to perform the processes disclosed herein. For example, embodiments of the disclosure may be practiced in various types of electrical circuits comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, aspects of the methods described herein can be practiced within a general purpose computer or in any other circuits or systems.

The description and illustration of one or more embodiments provided in this application are not intended, to limit or restrict the scope of the invention as claimed, in any way. The embodiments, examples, and details provided in this application are considered sufficient to convey possession and enable others to make and use the best mode of claimed invention. The claimed invention should not be construed as being limited to any embodiment, example, or detail provided, in this application. Regardless whether shown and described in combination or separately, the various features (both structural and methodological) are intended to be selectively included or omitted to produce an embodiment with a particular set of features. Having been provided, with the description and illustration of the present application, one skilled in the art may envision variations, modifications, and alternate embodiments falling within the spirit of the broader aspects of the claimed invention and the general inventive concept embodied in this application that do not depart from the broader scope.

1. A method of managing a secure enterprise comprising a plurality of communicatively interconnected endpoints, the method comprising:
initiating a management service at a server within the secure enterprise, the management service including a web interface providing administrative access to configuration settings associated with the secure enterprise, the management service initializing a secure communications protocol and managing access to a credential store, the credential store including a plurality of credentials defining communities of interest within the secure enterprise, each of the communities of interest defining a collection of authenticated endpoints having common access and usage rights;
initiating an object management service at the server, the object management service defining an interface to a configuration database, the configuration database storing:
configuration settings included in one or more configuration profiles for the enterprise network; and
one or more interface definitions useable by the web interface to provide administrative access to the configuration settings;
accessing, via the object management service, the configuration database to obtain data defining a configuration of the enterprise according to a configuration profile; and
applying one or more configuration settings to the secure enterprise based on the data defining the configuration of the secure enterprise.

2. The method of claim 1, wherein the web interface includes a plurality of portlets, each of the plurality of portlets defining a management user interface.

3. The method of claim 2, wherein the web interface is managed by a portlet manager, the portlet manager providing access to the management user interface to a user based on authentication of the user as an administrator.

4. The method of claim 3, wherein the portlet manager defines a plurality of administrator roles providing access to the management user interface, each of the plurality of administrator roles having different access rights to the plurality of portlets.

5. The method of claim 2, wherein the plurality of portlets include portlets selected from the group consisting of:
an administrative portlet;
a monitoring portlet;
a configuration portlet;
a logging portlet;
an alerts portlet;
a software installation portlet;
a jobs portlet;
a provisioning portlet;
a filters portlet; and
a locking portlet.

6. The method of claim 1, wherein the web interface is accessible to a user of a remote computing system via a secure HTTP connection.

7. An enterprise management system executable on a computing system included within a secure enterprise including a network comprising a plurality of communicatively interconnected secured endpoints, the enterprise management system comprising:
a configuration database storing configuration settings included in one or more configuration profiles of an enterprise network and one or more interface definitions;
a management service executable by the computing system to provide access to a web interface, the web interface providing administrative access to configuration settings associated with the secure enterprise according to the one or more configuration profiles;
an object management service communicatively connected to the management service and executable by the computing system, the object management service defining an interface to the configuration database; and
a credential store managed by the management service and including a plurality of credentials defining communities of interest within the secure enterprise, each of the communities of interest defining a collection of authenticated endpoints having common access and usage rights.

8. The enterprise management system of claim 7, wherein the web interface managed by the management service is hosted by a portal management service, the portal management service hosting a plurality of portlets, each of the plurality of portlets providing access to one or more configuration options.

9. The enterprise management system of claim 8, wherein the portlets are defined based on a user role of an accessing user and provide access to configuration options based on the user role associated with each portlet.

10. The enterprise management system of claim 8, wherein the portal management service executes on a second computing system communicatively connected to the computing system.

11. The enterprise management system of claim 7, wherein the computing system comprises a virtual computing system hosted on a network of distributed computing systems.

12. The enterprise management system of claim 7, further comprising a third computing system within the network, the second computing system implementing a redundant enterprise management system.

13. A secured enterprise comprising a network including a plurality of servers and a plurality of secured endpoints, the secured enterprise comprising:
an enterprise management server hosting:
a management service providing access to a web interface to administrative users and managing access to a credential store, the credential store including a plurality of credentials defining communities of interest within the secure enterprise, each of the communities of interest defining a collection of authenticated endpoints having common access and usage rights; and
an object management service defining an interface to a configuration database hosted on the enterprise management server;
a user interface server communicatively connected to the enterprise management server, the user interface server providing the web interface hosting a plurality of portlets; and
an authorization server accessible to each of the secured endpoints, the authorization server providing credentials to authenticated secured endpoints associated with one or more of the communities of interest defined using the management service.

14. The secured enterprise of claim 13, further comprising a security appliance communicatively connected to the enterprise management server, the security appliance including a monitoring service and a dynamic licensing service.

15. The secured enterprise of claim 13, further comprising a mobile device gateway communicatively connected to the enterprise management server, the mobile device gateway providing a location at which a mobile device connects and authenticates a user of a mobile device external to the network as a member of a community of interest, thereby allowing secure communications with one or more of the plurality of secured endpoints within the network via the mobile device gateway.

16. The secured enterprise of claim 13, further comprising a licensing server communicatively connected to the enterprise management server and controlling licenses to secured endpoints based on a licensing file configured by the management service.

17. The secured enterprise of claim 16, wherein the licensing file is stored at one of the enterprise management server and the authorization server.

18. The secured enterprise of claim 13, further comprising a second enterprise management server hosting a redundant management service and a redundant object management service.

19. The secured enterprise of claim 13, wherein the management service provides an administrative management interface useable by an administrative user to define user roles, communities of interest, and user memberships within the communities of interest.

20. The secured enterprise of claim 13, wherein the configuration database maintains an object model of objects and users associated with the secured enterprise, the object model useable to manage accounts within the secured enterprise.
